(19) United States
(12) Patent Application Publication
(10) Pub. No.: US 2020/0213440 A1
(43) Pub. Date: Jul. 2, 2020

(54) Content Delivery Method, Apparatus and System

(71) Applicants: Siu Hong Ng, Kowloon (HK); Wai Kei Stephen Chan, Kowloon (HK)

(72) Inventors: Siu Hong Ng, Kowloon (HK); Wai Kei Stephen Chan, Kowloon (HK)

(21) Appl. No.: 16/633,581

(22) PCT Filed: Feb. 15, 2018
(86) PCT No.: PCT/IB2018/050915

§ 371 Date: Jan. 23, 2020

(51) Int. Cl. H04M 1/725

(52) U.S. Cl. CPC H04M 1/72547; H04M 1/72572; H04M 1/72566

(57) ABSTRACT

An apparatus and system for delivering content having an applicable time limit and/or access right, including a time content capsule/module (100), a location content capsule/module (200), and/or a life content capsule/module (300) being operably connected with each other; wherein the time content capsule/module (100) is configured for generation and delivery of a content/information capsule/module intended to be delivered to a designated recipient or group of recipients by a content sender and having an access time restriction; the location content capsule/module (200) is configured for generation and delivery of a content/information capsule/module intended to be delivered to a designated recipient or group of recipients by a content sender and having an access location restriction; and the life content capsule/module (300) is configured for generation and delivery of a content/information capsule/module intended to be delivered to a designated recipient or group of recipients by a content sender and having a user status restriction, so as to ensure that the content/information to be delivered would only be accessed under specific conditions.

### TECHNICAL FIELD

The present disclosure relates to a content delivery method and apparatus, and more particularly, to a method, an apparatus, and/or a system for delivering digital content or content data through a computer or communication network.

### BACKGROUND ART

There are a variety of content delivery methods and apparatuses, most of which adopt real-time delivery to make the overall content be delivered and circulated as quickly as possible. However, in some applications for delivery of specific and especially event-oriented or triggered content, the mainstream prior art content delivery methods and apparatuses are inapplicable thereto.

### BRIEF SUMMARY OF INVENTION

An aspect of the present disclosure at least relates to a content delivery apparatus comprising a processor, a user input interface, and a content data output device operatively connected with each other; wherein the processor is to execute stored instructions to present a menu on the content data output device for enabling selection of a recipient or a group of recipients for content and enabling generation or selection of a content/content data to be delivered and one or more predetermined limitations/restrictions, preferably including an access time restriction, an access location restriction, and/or a user status restriction, in relation to delivery and/or access of the content to be delivered; wherein the processor is configured to, in response to a selection or a predetermined restriction made at the user input interface, correspondingly generate and store and/or directly deliver a content information based on the selection or the predetermined restriction; wherein when the content information is to be stored rather than being sent directly, the processor is configured to manipulate a timer to track and store a user status, preferably including a pattern and/or a duration of user online/active time and/or user offline/inactive time; and preferably the processor is configured to send a verification message based on a result of tracking to confirm the user status, so as to update or reset the user status/sender status, and/or deliver the content information based on the selection or the predetermined restriction to a selected recipient or group of recipients according to confirmed or updated user/sender status.

According to the present disclosure, a smartphone is a suitable example of the content delivery apparatus disclosed herein.

### BRIEF DESCRIPTION OF DRAWINGS

The present disclosure will be described in details below with reference to the accompanying drawings, in which:

FIG. 1 is a block diagram of an exemplary content delivery apparatus/system according to the present disclosure;

FIG. 1A is a block diagram of another exemplary content delivery apparatus according to the present disclosure;

FIG. 2 is a logic flow diagram for content information transmission of an exemplary life content capsule according to the present disclosure; and

FIG. 3 is a logic flow diagram for accessing content information of an exemplary time and/or location content capsule according to the present disclosure.

### DETAILED DESCRIPTION OF INVENTION

The preferred embodiments of the present disclosure are provided below in conjunction with the drawings so as to describe the technical solutions of the present disclosure in details.

The present disclosure relates generally to event-oriented or event-triggered methods, apparatuses, and/or systems for delivering digital content or content data through a computer or communication network and based on based on predetermined time restrictions, location restrictions and/or status restrictions.

According to this disclosure, in certain specific applications related to personal privacy, content with applicable time restrictions and access rights, or the like, which often require the use of a non-real-time delivery and/or a delivery mechanism capable of setting predetermined access restrictions for transmitting at least one portion of a specific or even key content/information, such as time-bound promotional information and discount information of commercial and special events/activities as well as commercial and personal highly confidential information (such as notices for merger or business cooperation between a user/company and the other company, personal position promotion information, sender's preset/predetermined instruction and/or will or testament to a specific person/group or entity, or the like), such that the mainstream prior art content delivery methods and devices might not be applied thereto.

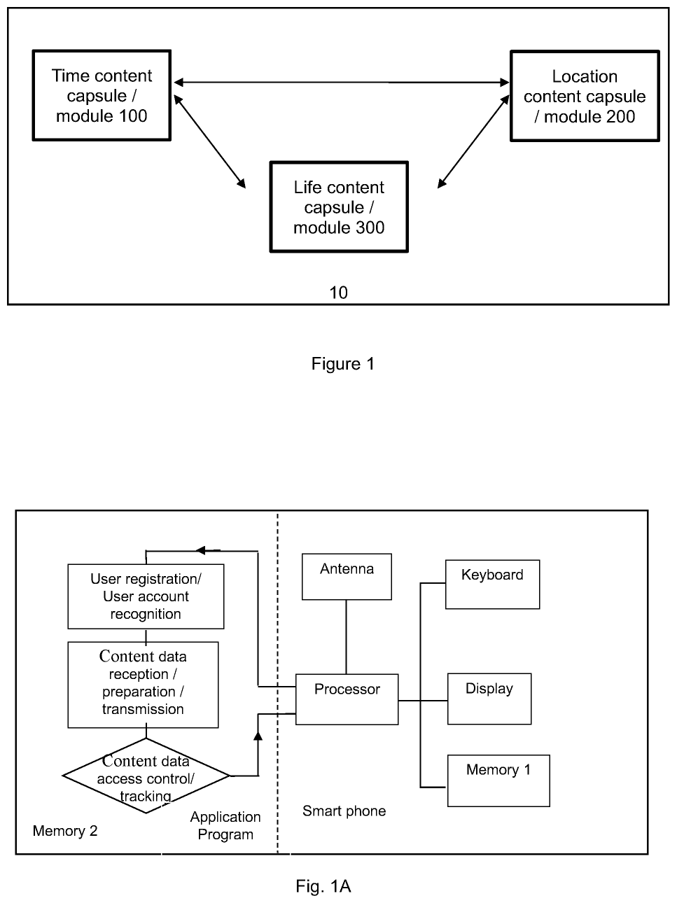

Referring to FIG. 1, a block diagram of an exemplary content delivery apparatus/system 10 according to the present disclosure is shown. The content delivery apparatus/system 10 includes a time content capsule/module 100, a location content capsule/module 200, and/or a life content capsule/module 300 operatively connected with each other. According to the embodiments of a content delivery apparatus/system of the present disclosure, the time content capsule/module 100 is configured for generation and delivery of a content/information capsule/module scheduled/intended to be delivered to a designated recipient or group of recipients by a content sender and having an access time restriction, so as to ensure that the content/information to be delivered would only be accessed during a specific time period, whereby preventing specific or critical content from being released prematurely or at inappropriate times, and allowing the content sender to review and rectify a specific or key content again before a preset disclosure time; the location content capsule/module 200 is configured for generation and delivery of a content/information capsule/module scheduled/intended to be delivered to a designated recipient or group of recipients by a content sender and having an access location restriction, so as to ensure that the content/information to be delivered would only be accessed at a specific physical location or area, whereby preventing the specific or critical content, such as promotional and discount information, from being disclosed at inappropriate locations and failed to work as intended or even work in opposite direction (for example, a person being interested in promotional offers for goods or services but located far away from the sender or the predetermined location may tends to contact directly other nearby providers or suppliers for similar goods or services), and helping to make sure that the specific or key content will only be received by the target person or people interested in the content being located within a predetermined range of area, thereby maximizing the effect of the content; and the life content capsule/module 300 is configured for generation and delivery of a content/information capsule/module scheduled/intended to be delivered to a designated recipient or group of recipients by a content sender and having a user status restriction, so as to ensure that the content/information to be delivered would only be accessed after a specific user status restriction has been lifted, whereby preventing the specific or critical content, such as a preset instruction and/or testament to other people/groups or organizations from being disclosed prematurely or at an inappropriate time and caused irreversible consequences, and allowing the content sender to review and rectify a specific or key content at any time before a preset disclosure time. Each of the above content capsules/modules can cooperate with or operate independently from each other as required or as per specific applications, as will be described in details below.

By the present disclosure, a sender or user could only deliver the content to other designated receivers/recipients or users at predetermined time and/or location (e.g. via the time and/or location content capsules based on the access time and/or location of the receiver). Alternatively, the present disclosure allows the user to deliver the content to other designated users at a predetermined time and/or location after passing away (e.g., via the life content capsule based on the status of the sender) Further, the present disclosure also allows the user to provide promotion or contest events to other users only at a fixed time and/or range of location (e.g., via a promotion or contest content capsule based on details of the promotion or contest).

The various content capsules/modules or content delivery capsules/modules (including time content capsule, location content capsule, and life content capsule) described herein are respectively corresponding to or referring to a content/information capsule/module, or its relevant preparation and transmitter-receiver (transceiver) unit probably in the form of a software module and/or a hardware module, scheduled/intended to be delivered to a designated recipient by a content sender and having an associated restriction or lock. For example, it might be various content/information or technical means to be accessed or displayed electronically, such as an electronic message or data used and accessed in a web page, an email, a communication application, or the like; or a preparation and transceiver unit in the form of a software module and/or a hardware module in association with each of the foregoing means.

The technical solution according to the present disclosure relates to a content delivery/transmission system, which involves a computing device used by a sender to define content and assign characteristics to the content (a predetermined time 1/start time, a predetermined time 2/end time, a predetermined location 1, a predetermined Inactive or offline time). In some embodiments, the user uses the time content capsule, the location content capsule, and/or the life content capsule to generate, send, and receive a restricted content, wherein the content might be encrypted and delivered to a server or cluster of servers (server side); and the content will be stored on the server.

Generally, according to the present disclosure, a processor of a content delivery apparatus will execute a stored instruction to present a menu and related options and functional units on a content data output device when using a time content capsule thereof, so that a user can select a recipient or a group of recipients for content, and generate or select the content to be delivered, and set an access time restriction in relation to delivery and/or access of the content to be delivered, such as a predetermined start time and/or end time at which the content is made accessible, so that the recipient or group of recipients could only access the content to be delivered between the start time and the end time. If the user only sets the start time, which means that the content to be delivered could be access after the start time without any restriction. When the user only sets the end time, which means that the content to be delivered could be accessed after it has been sent until the end time. After the operation for selecting and setting is done, the processor is configured to, in response to a selection or a predetermined restriction made at user input interface, correspondingly generate and store and/or directly deliver a content information based on the selection or the predetermined restriction, such as notices for merger or business cooperation between a user/company and the other company, personal position promotion information, sender's preset instruction and/or testament to a specific person/group or entity, or the like, wherein the content information could only be accessed by the recipient after the time restriction is lifted. The details for the use of the time content capsule will be elaborated below.

According to some embodiments of the present disclosure, when using the location content capsule, the processor of the content delivery apparatus will execute a stored instruction to present a menu and related options and functional units on the content data output device so that the user could select a recipient or a group of recipients for content, and generate or select the content to be delivered, and set a physical location restriction in relation to delivery and/or access of the content to be delivered, such as a specific area or area range or proximity at which the content to be delivered is made accessible, so that the recipient or group of recipients could only access the content to be delivered after arriving at or positioning within the specific area or area range. After the operation for selecting and setting is done, the processor is configured to, in response to a selection or a predetermined restriction made at user input interface, correspondingly generate and store and/or directly deliver a content information based on the selection or the predetermined restriction, such as time-bound promotional information and discount information of commercial and special events/activities, wherein the content information could only be accessed after the recipient has lifted the restriction. The details for the use of the location content capsule will be elaborated below.

According to other embodiments of the present disclosure, when employing the life content capsule, a processor of a content delivery apparatus will execute a stored instruction to present a menu and related options and functional units on a content data output device, so that the user can select a recipient or a group of recipients for content, and generate or select the content to be delivered, and set a user status restriction in relation to delivery and/or access of the content to be delivered, such as a pattern and/or a threshold for duration of user online/active time, user offline/inactive time, and/or a desired physiological parameter or vitality data or information of a user (especially the content sender), so that the recipient or group of recipients could only be allowed to access the content to be delivered or the will of the sender when it is determined that the sender's life status has changed. After selecting and setting operation is completed, the processor is configured to, in response to a selection or a predetermined restriction made at user input interface, correspondingly generate and store and/or directly deliver a content information based on the selection or the predetermined restriction, wherein The processor will operate a timer to track and store a physiological parameter or vitality data or information of the user or the user status, preferably including a pattern and/or a duration of user online/active time and/or user offline/inactive time; and preferably the processor is configured to send a verification message based on a result of tracking to confirm the user status, so as to update or reset the user status/sender status, and/or deliver the content information based on the selection or the predetermined restriction to a selected recipient or group of recipients according to confirmed or updated user/sender status, such as a preset instruction and/or will or the like that the sender wants to deliver to a specific person/group or entity after passing away, wherein the content information could only be accessed by the recipient after the status restriction of the sender is lifted. The details for the use of the life content capsule will be elaborated below.

In some embodiments, when using location content capsule and/or life content capsule to deliver a specific content, the server will only send first a relevant notification message to the computing device of the designated recipient or group of recipient rather than the specific/complete content.

In some embodiments, when using the life content capsule, the server will only send a relevant notification message rather than the specific/complete content to the computing device of the designated recipient or group of recipient after the duration of a system defined inactivity state exceeds a predetermined threshold. After receiving the notification message, the recipient could see from the GUI of the computing device that they have an unopened content, wherein they could see the content sender and an essential requirement for opening the content (predetermined time 1 and predetermined location 1). When the user taps or clicks on the message, the computing device is triggered to send a request to the server to verify whether the essential requirement for opening the full content have been met or satisfied.

In some embodiments, when using the time content capsule, the server will validate the time when server receiving the request (server time) with the relevant predetermined time 1 of the content. The server will mark the content as unlocked and return the full content in its response only if the following condition is met:
the server time is on or after the predetermined time 1 with time zone taken into consideration.

In some embodiments, when using the location content capsule, physical location (location 2), the mobile country code (MCC) and mobile network code (MNC) will be collected from the computing device (if applicable or available), such information will be included in the request and send to server. When the server receive the request, the origin/source IP address where the request is sent from and the time when the server received the request (server time) are also collected. The server will mark the content as unlocked and return the complete content in its response only if the following conditions are met:
the server time is on or after the predetermined time 1 with time zone taken into consideration; and
location 2 is within a certain range of predetermined location 1 of the content; and
any one of the following conditions is met:
   country derived from MCC/MNC is the same as predetermined location 1 of the content; and
   country derived from origin IP address is the same as predetermined location 1 of the content.

In some embodiments, when using the life content capsule, the server will mark the content as unlocked and return the relevant or complete content in its response only if the following condition is met:
time of inactivity or offline of the sender exceeds a system defined time threshold.

In some embodiments, if the server returns relevant or complete content in the response, the content will be stored on the computing device for viewing.

According to the present disclosure, it proposes to deliver an end user customization and control for content (such as text, video, image, voice message) by a time and location based activation operation.

In addition, the present disclosure allows for setting or preparing and transmitting a preset standard content capsule having at least one restriction or lock, and it allows for lifting of the at least one restriction and activation or unlock of the content capsule by the checking and comparison result for predetermined date and time and/or location (proximity) or by the confirmation of the death of a designated user or content sender. The confirmation of the death of the sender could be preferably determined by checking and verifying a change in pattern and/or a duration of online/active time and/or offline/inactive time of the sender or the content delivery apparatus operated by the sender. In some embodiments, the sender's life status could be determined by checking and verifying the change in pattern and/or the duration of online/active time and/or offline/inactive time of a smartphone or its application used by the sender, because the use of the smartphone has become indispensable to the daily life of most people, and an extremely prolonged period of non-use of the smartphone or its specific applications often indicates that the health, daily life, or life status of the smartphone owner or the content sender has changed dramatically, namely the sender is likely to have died. In this regard, the previously specified content of the sender should be delivered to its designated recipient as expected.

In some embodiments, the content delivery apparatus may be operatively connected and interactively cooperate with a smart wearable device, wherein the smart wearable device, such as a smart watch (including Apple watch, Android wear), a smart ring, a smart glasses, or other wearable devices capable of measuring a physiological or biometric parameter (including at least one of the following: heart rate, body temperature, blood pressure, skin resistance, brain waves, respiration rate, oxygen saturation) and other vital signs of the user. A real-time measurement result or a measurement result for a certain period of time or duration might be transmitted to the content delivery apparatus to facilitate further confirmation of the life status of the sender; and wherein acquirement/provision of a direct or supporting evidence for determining whether the sender is still alive might be realized by comparing the measurement result with a pre-stored historical data of a specific user/sender. In some embodiments, it allows for generation or configuration of an event/contest or promotion content capsule having at least one restriction or lock, and it allows for lifting of the at least one restriction and activation or unlock of the content capsule by the checking and comparison result for predetermined date and time and/or location (proximity) thereof.

In some embodiments, it allows for generation or configuration of a series of contest/promotion content capsules and a sequential activation is allowed (ie, the user is required to activate sequentially the first and the subsequent second content capsules, while the activation of the second content capsule might depend on the activation result of the first content capsule).

In some embodiments, the present disclosure could only allow for setting all of content capsules in the future rather than in the past; and/or other specified users is limited to open or activate the content capsule at a required location (or within a nearby range of locations); and/or other specified users is required to open or activate the event/promotion content capsule at or within a preset time limit and could not open an expired content capsule or a content capsule fall beyond the preset time limit; and/or the designated recipient for the content capsule could only receive the life content capsule or related information/notifications set by the sender after the sender passed away or his continuous inactivity time reaches a predetermined threshold.

In another aspect of the present disclosure, it relates to substantially a content delivery apparatus comprising a processor, a user input interface, and a content data output device operatively connected with each other; wherein the processor is to execute stored instructions to present a menu on the content data output device for enabling selection of a recipient or a group of recipients for content and enabling generation or selection of a content/content data to be delivered and one or more predetermined limitations/restrictions, preferably including an access time restriction, an access location restriction, and/or a user status restriction, in relation to delivery and/or access of the content to be delivered; wherein the processor is configured to, in response to a selection or a predetermined restriction made at the user input interface, correspondingly generate and store and/or directly deliver a content information based on the selection or the predetermined restriction; wherein when the content information is to be stored rather than being sent directly, the processor is configured to manipulate a timer to track and store a user status, preferably including a pattern and/or a duration of user online/active time and/or user offline/inactive time; and preferably the processor is configured to send a verification message based on a result of tracking to confirm the user status, so as to update or reset the user status/sender status, and/or deliver the content information based on the selection or the predetermined restriction to a selected recipient or group of recipients according to confirmed or updated user/sender status.

In some embodiments, the access time restriction comprising a specific time or time range at which the content to be delivered is made accessible; and/or the access location restriction comprising a specific area or area range at which the content to be delivered is made accessible; and/or the user status restriction comprising a specific status/state or condition at which the content to be delivered is made accessible including a change in pattern and/or a duration of user online/active time and/or user offline/inactive time.

In other embodiments, the verification message comprises an e-mail, a SMS, a MMS, and/or an inquiry message based on a real-time communication software in an interactive format for confirming the user status by receipt of a response; wherein the processor is to reset the user status when a corresponding response is received, otherwise it will updates the user status until a predetermined status or threshold is reached and/or delivers the content information based on the selection or the predetermined restriction to the selected recipient or group of recipients.

In some embodiments, the processor is to generate the content information based on the selection or the predetermined restriction so as to display an information or its tooltip/screentip/popover on the content data output device, and the content information comprises a resettable parameter, or an incrementable and/or variable state or value, in relation to lifting of a predetermined restriction; and the processor is to deliver the content information based on the selection or the predetermined restriction to the selected recipient or group of recipients when the state or value becomes a predetermined value or threshold; and/or the content information comprises an information for at least a portion or an abstract of content and/or a relevant information for indicating or giving a hint of a condition to be met or a restriction to be lifted before accessing a complete version of content or content data.

In some embodiments, the content data output device is a display unit; and the content data comprises a hyperlink, a video data, and/or a text data adapted for display on the display unit.

In another aspect of the present disclosure, it relates to substantially a content delivery apparatus comprising a processor configured to be able to provide a content information with a selected recipient or a group of recipients and one or more predetermined restrictions in relation to accessing content/content data, preferably including an access time restriction, an access location restriction, and/or a user/sender state restriction, in response to a user request or an automatically generated periodical/timely request upon execution of a stored instruction; wherein the processor is to execute a stored instruction to determine/check whether a current user is/belongs to the selected recipient or group of recipients, and determine correspondingly whether a predetermined restriction has been met or lifted so as to determine whether there is a need to provide the content information in response to the predetermined restriction; wherein when checking a user status/sender status, the processor is configured to manipulate a timer to track and store the user status, preferably including a pattern and/or a duration of user online/active time and/or user offline/inactive time; and wherein the processor is preferably configured to send a verification message based on a result of tracking to confirm the user status, so as to update or reset the user status, and/or deliver the content information to a selected recipient or group of recipients according to confirmed or updated user status.

In some embodiments, when determining whether the predetermined restriction has been met or lifted, the processor is to execute a stored instruction to determine whether current time meets the access time restriction, whether current location coordinate meets the access location restriction, and/or whether current user/sender status meets the user/sender state restriction, so as to determine whether there is a need to provide the content information; and/or the verification message comprises an e-mail, a SMS, a MMS, and/or an inquiry message based on a real-time communication software in an interactive format for confirming the user status by receipt of a response; wherein the processor is to reset the user status when a corresponding response is received, otherwise it will updates the user status until a predetermined status or threshold is reached and/or delivers the content information based on the predetermined restriction to the selected recipient or group of recipients; and/or the content information comprises an information for at least a portion or an abstract of content and/or a relevant information for indicating or giving a hint of a condition to be met or a restriction to be lifted before accessing a complete version of content or content data.

In other embodiments, when determining whether a predetermined restriction has been met or lifted, the processor is to execute a stored instruction to check whether current time is earlier than an information opening time defined in the access time restriction or within an information opening time period defined in the access time restriction, so as to determine whether the content information should be provided.

In further embodiments, when determining whether the predetermined restriction has been met or lifted, the processor is to execute a stored instruction to request for provision of current location coordinates, checking whether the current location coordinate match with the MCC and MNC codes of a corresponding mobile communication operator and/or checking whether the current location coordinate and current IP source address/location belong to same country or region, so as to determine whether the content information should be provided.

In yet another aspect of the present disclosure, it generally relates to a system for content delivery, comprising at least one apparatus as described above being operably connected with each other.

In yet still another aspect of the present disclosure, it generally relates to a content delivery method, comprising:
having a processor to execute stored instructions to present a menu on a content data output device for enabling selection of a recipient or a group of recipients for content and enabling generation or selection of a content/content data to be delivered and one or more predetermined limitations/restrictions, preferably including an access time restriction, an access location restriction, and/or a user status restriction, in relation to delivery and/or access of the content to be delivered;
having the processor to, in response to a selection or a predetermined restriction made at the user input interface, correspondingly generate and store and/or directly deliver a content information based on the selection or the predetermined restriction; and
when the content information is to be stored rather than being sent directly, having the processor configured to manipulate a timer to track and store a user status, preferably including a pattern and/or a duration of user online/active time and/or user offline/inactive time; and preferably having the processor configured to send a verification message based on a result of tracking to confirm the user status, so as to update or reset the user status/sender status, and/or deliver the content information based on the selection or the predetermined restriction to a selected recipient or group of recipients according to confirmed or updated user/sender status.

In another aspect of the present disclosure, it generally relates to a content delivery method, comprising:
having a processor configured to be able to provide a content information with a selected recipient or a group of recipients and one or more predetermined restrictions in relation to accessing content/content data, preferably including an access time restriction, an access location restriction, and/or a user/sender state restriction, in response to a user request or an automatically generated periodical/timely request upon execution of a stored instruction;
having the processor to execute a stored instruction to determine/check whether a current user is/belongs to the selected recipient or group of recipients, and determine correspondingly whether a predetermined restriction has been met or lifted so as to determine whether there is a need to provide the content information in response to the predetermined restriction;
when checking a user status/sender status, having the processor configured to manipulate a timer to track and store the user status, preferably including a pattern and/or a duration of user online/active time and/or user offline/inactive time;
preferably having the processor configured to send a verification message based on a result of tracking to confirm the user status, so as to update or reset the user status, and/or deliver the content information to a selected recipient or group of recipients according to confirmed or updated user status.

According to the present disclosure and as depicted with reference to FIG. 1A, an exemplary content delivery apparatus or system comprises a smart phone and a server connected to a communication network, the communication network including a telecommunications network, a computer network and/or the Internet. The smart phone is an example of a portable mobile apparatus and comprises in general a main body, a microprocessor, a memory, a display screen and other input/output interfaces, and telecommunications interfaces. The input/output interfaces may comprise a keyboard, a USB port, a wireless data or WLAN port, or a touch screen panel which might function both as an input device and an output device. Most components of the smart phone, for example, the microprocessor, the memory, the display screen, the input/output interfaces, and/or the telecommunications interface, are mounted on a printed circuit board or assembled as a module.

According to the present disclosure, an application program facilitating content data operations (including user registration, user account recognition, content data preparation, content data reception, content data delivery, content delivery/access control and tracking) is downloaded and stored in the memory of the smart phone as a resident program prior to actuation of the content delivery operations. Upon execution of instructions which are stored in the memory, the processor will load the application program and generate a user interface, for example, a graphic user interface, on the display screen to facilitate user interactive operations. A user will then interact with the smart phone through the user interface to register and then to operate the smart phone as an example content delivery apparatus to select, prepare/generate, and deliver content data. The content data may include video data, audio data, or other digital data.

To facilitate activation of operations, the processor will generate a sign-in screen upon actuation of the resident application program. The sign-in screen displays icons for user log in and for new user registration. To participate in interactive operations according to the present disclosure, a user will need to obtain and register an account first or as a start at the sign in page. To obtain a user account and password, a new user will need to provide personal information such as user name, gender, email address, mobile phone number, and/or other personal profile information such as age, nationality, occupation, family status, etc. A user profile containing the foregoing personal information will be set up for each user account and stored in a remote or main server, although the server may be a distributed server without loss of generality.

The content data used herein may include audio data, video data, text data, image data, digital data, and/or Uniform Resource Identifier (URI) or any combination of them without loss of generality.

In an exemplary application of the present disclosure, a content data transfer request sent from a smartphone acting as an exemplary content delivery apparatus is received by a server (for example, a remote server/cloud server). Once the content data request is received, the remote server performs user authentication. With proper authentication, it could be determined that the content data request is originated from an authorized source (such as a dedicated application and a designated recipient), so as to conduct subsequent operations.

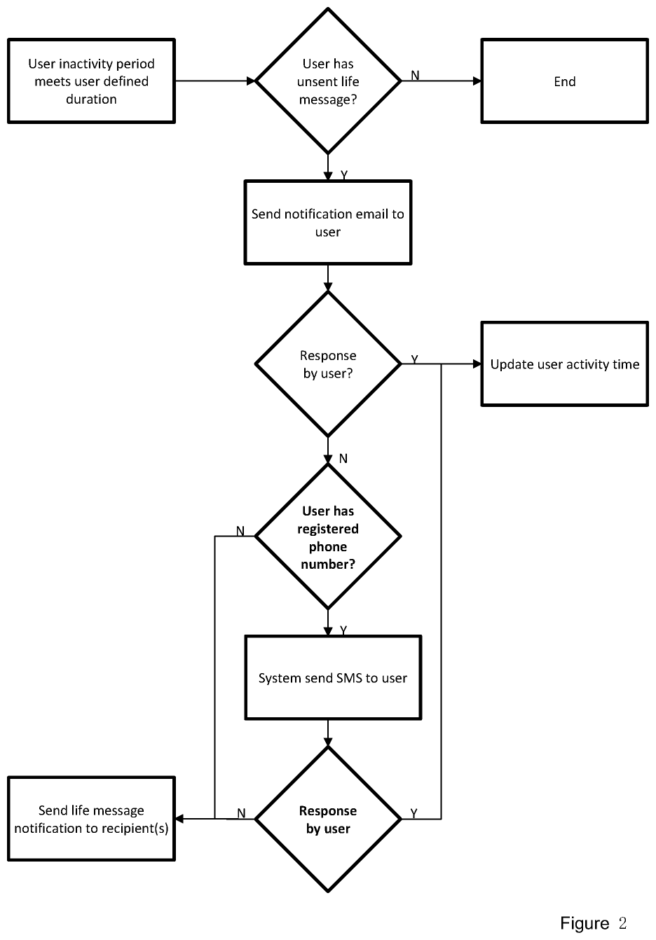

Referring to FIG. 2, a logic flow diagram of content information transmission of an exemplary life content capsule according to the present disclosure is shown. In this embodiment, when the apparatus or system detects that the user is inactive or offline for a duration exceeding a defined threshold, it will check whether the user has an unsent life based message (a testament or specific message). If positive, it could send selectively an email or notification to the user. If the user responds to the email or notification, the apparatus or system updates the latest/last active time of the user, otherwise it will check whether the user has other channels or means for contact. For example, it will check whether a phone number is registered. If positive, it will then send a SMS, a MMS, and/or an inquiry message based on a real-time communication software to the user. If the user timely responds, the apparatus or system will update the last active time of the user, otherwise it will deliver a notification for the testament or the specific message to a message recipient or group of recipients specified by the sender.

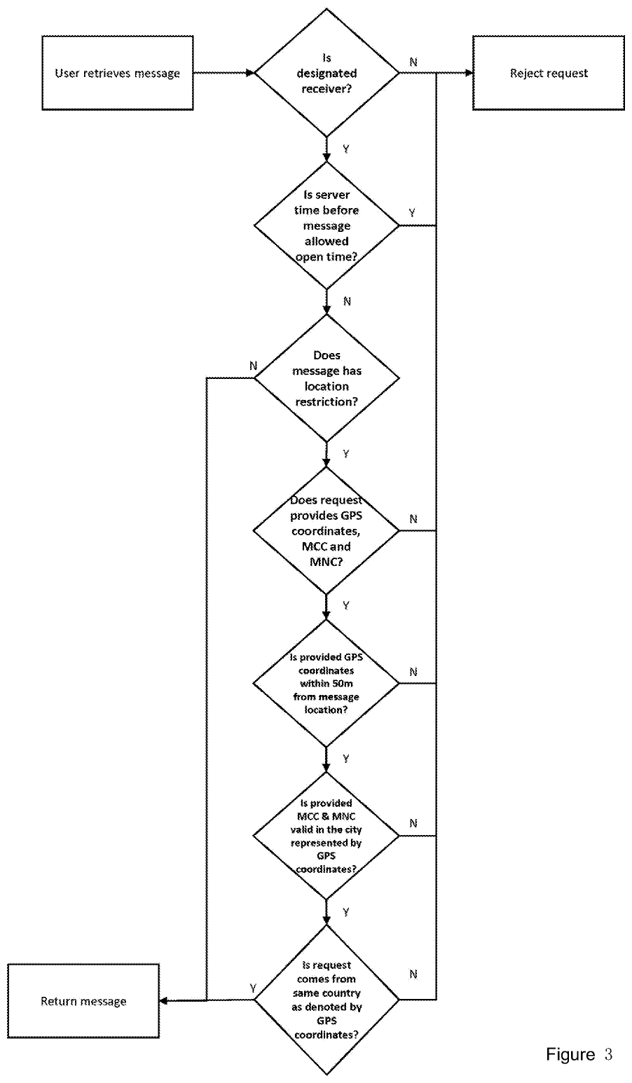

Referring to FIG. 3, which depicts a logic flow diagram for accessing content information of an exemplary time and/or location content capsule according to the present disclosure. In this embodiment, when a user accesses a relevant message/information or content, the system or server checks whether the user is a designated recipient. If the result is negative, then it declines the user's access request, otherwise the server will check whether the current time is after the preset message opening time. If the result is negative, the user's access request will be rejected, otherwise it will check whether the message has any other restrictions, such as an access location coordinate restriction. If the result is negative, it will return the content of message, otherwise it will request for the provision of location coordinate, operator's MCC code and/or MNC code. If the request fails, the user's access request will be rejected, otherwise it will check whether the location coordinate is within a predetermined range of access location coordinate for the message. For instance, it will check whether the location coordinate is within 50 meters of the range. If the result is negative, the user's access request will be rejected; otherwise, it will check selectively whether the requested IP source address and the location coordinate belong to the same country. As shown in FIG. 3, if the result is negative, the user's access request will be rejected, otherwise the message content will be returned.

In yet another aspect of the present disclosure, it generally relates to a content delivery method, wherein when manipulating a time content capsule, a sender could create a content of any combination of text, image, video, audio and/or URI, on any content delivery apparatus or computing device (including smartphone, tablet, portable computer, desktop computer, or the like); and
the sender will mandatorily assign a target recipient or group of recipients of the content; and
mandatorily assign a predetermined date, time and time zone (predetermined time 1) to the content so that the content can only be read on or after the predetermined time 1; and
preferably, mandatorily assign a predetermined additional date, time and time zone (predetermined time 2) to the content so that the content can only be read on or after the predetermined time 1 and before the predetermined time 2.

In some embodiments, when manipulating a time and/or location content capsule, a sender could create a content of any combination of text, image, video, audio and/or URI, on any computing device (including smartphone, tablet, portable computer, desktop computer, or the like); and
the sender will mandatorily assign a target recipient or group of recipients of the content; and
mandatorily assign a predetermined date, time and time zone (predetermined time 1) to the content so that the content can only be read on or after the predetermined time 1; and
preferably, mandatorily assign a predetermined additional date, time and time zone (predetermined time 2) to the content so that the content can only be read on or after the predetermined time 1 and before the predetermined time 2; and
preferably, mandatorily assign a designated location information (a predetermined location 1) to the content so that the content can only be read on or after the predetermined time 1 and before the predetermined time 2 (if assigned) and within a specific range of the predetermined location 1.

In some embodiments, when manipulating a life content capsule, a sender could create a content of any combination of text, image, video, audio and/or URI, on any computing device (including smartphone, tablet, portable computer, desktop computer, or the like); and
mandatorily assign a target recipient or group of recipients of the content.

Accordingly, when manipulating a time content capsule, a recipient could receive a notification about a receipt of a time based content on a content delivery apparatus or computing device;
wherein the content can only be accessed/opened on or after a predetermined time 1; and
if a predetermined time 2 is assigned, the content will be locked and cannot be accessed/opened after the predetermined time 2.

In some embodiments, when manipulating a location content capsule, a recipient could receive a notification about a receipt of a location based content on a content delivery apparatus or computing device;
wherein the content can only be accessed/opened on or after a predetermined time 1 and within a specific range of an assigned physical location; and
if a predetermined time 2 is assigned, the content will be locked and cannot be accessed/opened after the predetermined time 2.

In some embodiments, when manipulating a life content capsule, a recipient could receive a notification about a receipt of a life based content on a content delivery apparatus or computing device when an inactive or offline time of sender defined in system is lapsed and exceeded a preset threshold value; and
preferably, the content can only be accessed/opened without further restriction so as to ensure that the notification could be accessed successfully by a recipient designated by the sender.

Though the present disclosure is described by way of example with reference to the accompanying drawings, but the examples and drawings are exemplary and should not be used to limit the scope of the present disclosure. For example, while a smartphone has been used as an exemplary content delivery apparatus, but a desktop computer, a portable computer, a laptop or notebook computer, a tablet computer, a smart TV or a game console could be adopted as a content delivery apparatus without loss of generality.

1. A content delivery apparatus comprising a processor, a user input interface, and a content data output device operatively connected with each other; wherein the processor is to execute stored instructions to present a menu on the content data output device for enabling selection of a recipient or a group of recipients for content and enabling generation or selection of a content/content data to be delivered and one or more predetermined limitations/restrictions, preferably including an access time restriction, an access location restriction, and/or a user status restriction, in relation to delivery and/or access of the content to be delivered; wherein the processor is configured to, in response to a selection or a predetermined restriction made at the user input interface, correspondingly generate and store and/or directly deliver a content information based on the selection or the predetermined restriction; wherein when the content information is to be stored rather than being sent directly, the processor is configured to manipulate a timer to track and store a user status, preferably including a pattern and/or a duration of user online/active time and/or user offline/inactive time; and preferably the processor is configured to send a verification message based on a result of tracking to confirm the user status, so as to update or reset the user status/sender status, and/or deliver the content information based on the selection or the predetermined restriction to a selected recipient or group of recipients according to confirmed or updated user/sender status.

2. The apparatus of claim 1, wherein the access time restriction comprising a specific time or time range at which the content to be delivered is made accessible; and/or the access location restriction comprising a specific area or area range at which the content to be delivered is made accessible; and/or the user status restriction comprising a specific status/state or condition at which the content to be delivered is made accessible including a change in pattern and/or a duration of user online/active time and/or user offline/inactive time.

3. The apparatus of claim 1, wherein the verification message comprises an e-mail, a SMS, a MMS, and/or an inquiry message based on a real-time communication software in an interactive format for confirming the user status by receipt of a response; wherein the processor is to reset the user status when a corresponding response is received, otherwise it will updates the user status until a predetermined status or threshold is reached and/or delivers the content information based on the selection or the predetermined restriction to the selected recipient or group of recipients.

4. The apparatus of claim 1, wherein the processor is to generate the content information based on the selection or the predetermined restriction so as to display an information or its tooltip/screentip/popover on the content data output device, and the content information comprises a resettable parameter, or an incrementable and/or variable state or value, in relation to lifting of a predetermined restriction; and the processor is to deliver the content information based on the selection or the predetermined restriction to the selected recipient or group of recipients when the state or value becomes a predetermined value or threshold; and/or the content information comprises an information for at least a portion or an abstract of content and/or a relevant information for indicating or giving a hint of a condition to be met or a restriction to be lifted before accessing a complete version of content or content data.

5. The apparatus of claim 1, wherein the content data output device is a display unit; and the content data comprises a hyperlink, a video data, and/or a text data adapted for display on the display unit.

6. A content delivery apparatus comprising a processor configured to be able to provide a content information with a selected recipient or a group of recipients and one or more predetermined restrictions in relation to accessing content/content data, preferably including an access time restriction, an access location restriction, and/or a user/sender state restriction, in response to a user request or an automatically generated periodical/timely request upon execution of a stored instruction; wherein the processor is to execute a stored instruction to determine/check whether a current user is/belongs to the selected recipient or group of recipients, and determine correspondingly whether a predetermined restriction has been met or lifted so as to determine whether there is a need to provide the content information in response to the predetermined restriction; wherein when checking a user status/sender status, the processor is configured to manipulate a timer to track and store the user status, preferably including a pattern and/or a duration of user online/active time and/or user offline/inactive time; and wherein the processor is preferably configured to send a verification message based on a result of tracking to confirm the user status, so as to update or reset the user status, and/or deliver the content information to a selected recipient or group of recipients according to confirmed or updated user status.

7. The content delivery apparatus of claim 6, wherein when determining whether the predetermined restriction has been met or lifted, the processor is to execute a stored instruction to determine whether current time meets the access time restriction, whether current location coordinate meets the access location restriction, and/or whether current user/sender status meets the user/sender state restriction, so as to determine whether there is a need to provide the content information; and/or the verification message comprises an e-mail, a SMS, a MMS, and/or an inquiry message based on a real-time communication software in an interactive format for confirming the user status by receipt of a response; wherein the processor is to reset the user status when a corresponding response is received, otherwise it will updates the user status until a predetermined status or threshold is reached and/or delivers the content information based on the predetermined restriction to the selected recipient or group of recipients; and/or the content information comprises an information for at least a portion or an abstract of content and/or a relevant information for indicating or giving a hint of a condition to be met or a restriction to be lifted before accessing a complete version of content or content data.

8. The content delivery apparatus of claim 6, wherein when determining whether a predetermined restriction has been met or lifted, the processor is to execute a stored instruction to check whether current time is earlier than an information opening time defined in the access time restriction or within an information opening time period defined in the access time restriction, so as to determine whether the content information should be provided.

9. The content delivery apparatus of claim 1, wherein when determining whether the predetermined restriction has been met or lifted, the processor is to execute a stored instruction to request for provision of current location coordinates, checking whether the current location coordinate match with the MCC and MNC codes of a corresponding mobile communication operator and/or checking whether the current location coordinate and current IP source location belong to same country or region, so as to determine whether the content information should be provided.

10. (canceled)

11. The system for delivering content having an applicable time limit and/or access right as in claim 1, comprising
a content delivery apparatus comprising a processor configured to be able to provide a content information with a selected recipient or a group of recipients and one or more predetermined restrictions in relation to accessing content/content data, preferably including an access time restriction, an access location restriction, and/or a user/sender state restriction, in response to a user request or an automatically generated periodical/timely request upon execution of a stored instruction; wherein the processor is to execute a stored instruction to determine/check whether a current user is/belongs to the selected recipient or group of recipients, and determine correspondingly whether a predetermined restriction has been met or lifted so as to determine whether there is a need to provide the content information in response to the predetermined restriction; wherein when checking a user status/sender status, the processor is configured to manipulate a timer to track and store the user status, preferably including a pattern and/or a duration of user online/active time and/or user offline/inactive time; and wherein the processor is preferably configured to send a verification message based on a result of tracking to confirm the user status, so as to update or reset the user status, and/or deliver the content information to a selected recipient or group of recipients according to confirmed or updated user status; and/or
a time content capsule/module (100), a location content capsule/module (200), and/or a life content capsule/module (300) being operably connected with each other; wherein the time content capsule/module (100) is configured for generation and delivery of a content/information capsule/module scheduled/intended to be delivered to a designated recipient or group of recipients by a content sender and having an access time restriction, so as to ensure that the content/information to be delivered would only be accessed during a specific time period; the location content capsule/module (200) is configured for generation and delivery of a content/information capsule/module scheduled/intended to be delivered to a designated recipient or group of recipients by a content sender and having an access location restriction, so as to ensure that the content/information to be delivered would only be accessed at a specific physical location or area; and the life content capsule/module (300) is configured for generation and delivery of a content/information capsule/module scheduled/intended to be delivered to a designated recipient or group of recipients by a content sender and having a user status restriction, so as to ensure that the content/information to be delivered would only be accessed after a specific user status restriction has been lifted.

12. The system for delivering content of claim 10, further comprising a smart wearable device capable of measuring a physiological parameter or a vital sign of a user body, and adapted for delivering a real-time measurement result or a measurement result of a specific time period or duration to the system for delivering content to facilitate further determination of life status of content sender; and preferably wherein acquirement/provision of a direct or supporting evidence for determining whether the content sender is still alive is realized by comparing the measurement result with a pre-stored historical data.

13. The system for delivering content of claim 10, wherein the system is configured to perform a content delivery method, comprising:
having a processor to execute stored instructions to present a menu on a content data output device for enabling selection of a recipient or a group of recipients for content and enabling generation or selection of a content/content data to be delivered and one or more predetermined limitations/restrictions, preferably including an access time restriction, an access location restriction, and/or a user status restriction, in relation to delivery and/or access of the content to be delivered;
having the processor to, in response to a selection or a predetermined restriction made at the user input interface, correspondingly generate and store and/or directly deliver a content information based on the selection or the predetermined restriction; and
when the content information is to be stored rather than being sent directly, having the processor configured to manipulate a timer to track and store a user status, preferably including a pattern and/or a duration of user online/active time and/or user offline/inactive time; and preferably having the processor configured to send a verification message based on a result of tracking to confirm the user status, so as to update or reset the user status/sender status, and/or deliver the content information based on the selection or the predetermined restriction to a selected recipient or group of recipients according to confirmed or updated user/sender status.

14. The system for delivering content of claim 10, wherein the system is configured to perform a content delivery method, comprising:
having a processor configured to be able to provide a content information with a selected recipient or a group of recipients and one or more predetermined restrictions in relation to accessing content/content data, preferably including an access time restriction, an access location restriction, and/or a user/sender state restriction, in response to a user request or an automatically generated periodical/timely request upon execution of a stored instruction;
having the processor to execute a stored instruction to determine/check whether a current user is/belongs to the selected recipient or group of recipients, and determine correspondingly whether a predetermined restriction has been met or lifted so as to determine whether there is a need to provide the content information in response to the predetermined restriction;
when checking a user status/sender status, having the processor configured to manipulate a timer to track and store the user status, preferably including a pattern and/or a duration of user online/active time and/or user offline/inactive time;
preferably having the processor configured to send a verification message based on a result of tracking to confirm the user status, so as to update or reset the user status, and/or deliver the content information to a selected recipient or group of recipients according to confirmed or updated user status.
